(19) United States
(12) Patent Application Publication
(10) Pub. No.: US 2021/0192432 A1
(43) Pub. Date: Jun. 24, 2021

(54) Management of Reusable Foodservice Ware

(71) Applicant: DeliverZero, Inc., Brooklyn, NY (US)

(72) Inventor: Adam Farbiarz, Brooklyn, NY (US)

(73) Assignee: DeliverZero, Inc., Brooklyn, NY (US)

(21) Appl. No.: 16/953,024

(22) Filed: Nov. 19, 2020

Related U.S. Application Data
(60) Provisional application No. 62/953,321, filed on Dec. 24, 2019.

(51) Int. Cl. G06Q 10/08; G06Q 50/12; G06Q 30/06; G06F 16/23

(52) U.S. Cl. CPC G06Q 10/087; G06F 16/2365; G06Q 30/0601; G06Q 50/12

(57) ABSTRACT

A method of managing an inventory of reusable food service ware. Reusable food service ware is provided to various restaurants. An order is received on a website from a customer for at least one food item at one of the restaurants. The order is transmitted from the website to the restaurant which completes the order by placing the food items in one or more of the units of the reusable food service ware. A first count of the number of the reusable food service ware units used to complete the order is received, followed by a second count of the number of the reusable food service ware units received from the customer. In a database a first record associated with the customer including a third count of outstanding reusable food service ware units is updated according to the first count and the second count.

### FIELD

The subject matter of the present disclosure relates to inventory management of reusable food containers.

### BACKGROUND

Food delivery is often accomplished using single use packaging or packaging that is only suitable for potential reuse within a household for a limited number of times. Restaurants do not collect or otherwise reuse their packaging and this creates an inevitable volume of trash, often which is plastic and particularly bad for the environment.

Restaurants do not employ truly reusable food service ware such as borosilicate glass containers as this would greatly increase the cost of delivery to the customer. Moreover, customers would not want to receive a consistent stream of such items which quickly account for more reusable containers than they need for their household.

Thus the restaurant industry produces a consistent stream of new delivery ware that requires disposal. Attempts to address these problems have so far not succeeded. For example, in one system a customer subscribes to service and is entitled to check out as many reusable takeout containers as the subscription permits. For example, if the customer has a single subscription, she can check out one takeout container; if she has a double subscription, she is allowed to checkout two boxes, etc. The customer then walks into a restaurant and shows her subscription on her phone; this proves to the restaurant that the customer is allowed to (for example, if she has a double subscription) check out two takeout containers. The restaurant then gives the customer no more than two containers. The system does not allow the customer to exceed her subscription (which means she can't get food in reusables that would exceed her subscription) and it does not give the restaurant freedom to pack her food in more than the subscribed-to number of containers, or to adjust upward the number of containers checked out to the customer. Containers are returned by the honor system and the customer locates a publicly available hamper (usually in a restaurant), and on her phone indicates that she is depositing her container(s) into the hamper. Therefore, there is no way to ensure that users actually return their containers. The subject matter of the present disclosure is directed to overcoming, or at least reducing the effects of, one or more of the problems set forth above.

### SUMMARY

Disclosed is a method and system for managing an inventory of reusable food service ware as distributed among a set of restaurants and used by a set of customers. For the purpose of this disclosure a reusable food service ware (FSW) unit is a discrete food service item such as a container or set of silverware that is considered a unit.

A set of FSW units is distributed to a number of food sellers, such as restaurants. Customers visit a webpage run by the distributor of the FSW units and peruse the food sellers' menus and make orders. When an order is placed, the order is electronically transmitted to the food seller, who packages the food in FSW units in stock and delivers it to the food buyer. The customer then eats the food and retains possession of the FSW units. At a later time, the customer visits the website and orders food again, however this time from a new food seller. Similarly to before, the order is transmitted and carried out. However, when the new food seller delivers the food and the FSW units, the new food seller simultaneously recovers the old FSW units that the original food seller delivered, and brings the old FSW units back to the new food seller for washing and reuse. At each stage the food seller or their proxy records the number of FSW units delivered and recovered and transmits those to the database of the FSW units distributor. The FSW unit distributor tracks the number of outstanding FSW units in possesses of the customer and the food sellers, and can, for instance, charge the customer for unreturned FSW units after a time or restock the food sellers with additional FSW units when they run low.

### BRIEF DESCRIPTION OF THE DRAWINGS

The foregoing summary, preferred embodiments, and other aspects of the present disclosure will be best understood with reference to a detailed description of specific embodiments, which follows, when read in conjunction with the accompanying drawings, in which:

FIG. 1 is a diagram of elements interacting during an embodiment.

FIG. 2 is a flow chart of an embodiment.

FIG. 3 depicts a user interface of an embodiment in which the number of FSW units outgoing is input.

FIG. 4 depicts a user interface of an embodiment in which the number of FSW units received is input.

Like reference numbers and designations in the various drawings indicate like elements.

### DETAILED DESCRIPTION

Disclosed is a system and method for recording and tracking an inventory of reusable packaging and reusable foodservice ware (collectively, “FSW units”) that is distributed among the inventory's owner; food sellers (such as restaurants) using the FSW; couriers; and food buyers (or end consumer) who takes possession of, and return, the FSW.

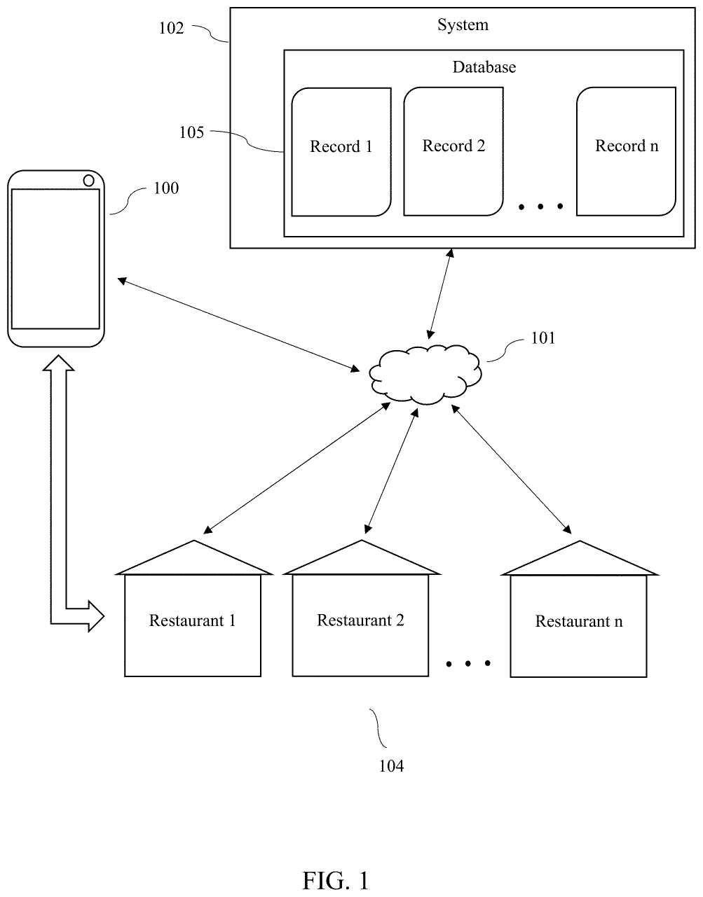

FIG. 1 depicts elements interacting during an embodiment method. An individual interacts with user device 100 seeking to place an order for food. Through network 101, such as the internet, user device interacts with system 102 to view restaurants and their respective menu selections, preferably through a web browser. Alternatively, the user may interact with restaurants 104 directly through their website or a third-party web platform that supports embodiments of the present disclosure.

The operator of system 102 separately engages with restaurants 104 and provides them with FSW units and records the number each restaurant possesses in a record in database 105 associated with each respective restaurant. Once the user has made a selection and orders a food item the selected restaurant prepares it and places in an appropriate number of FSW units. The restaurant then submits to system 102 the number of FSW units used in the order. Database 105 is updated to reflect both the number of FSW units that have been dispatched to the user and that are no longer in the inventory of the restaurant.

The restaurant then provides the food to the user, which may be accomplished in several manners. In a first embodiment, the restaurant provides the order directly to the user, which may be via pick-up or via a courier working for the restaurant. In this case, when interacting with the user the user will provide any number of FSW units. These FSW units may be from the same restaurant that the user is ordering from but may also be from any of the other restaurants 104. Alternatively if a third party courier is used to deliver the food that courier can provide the number of FSW units returned by the user.

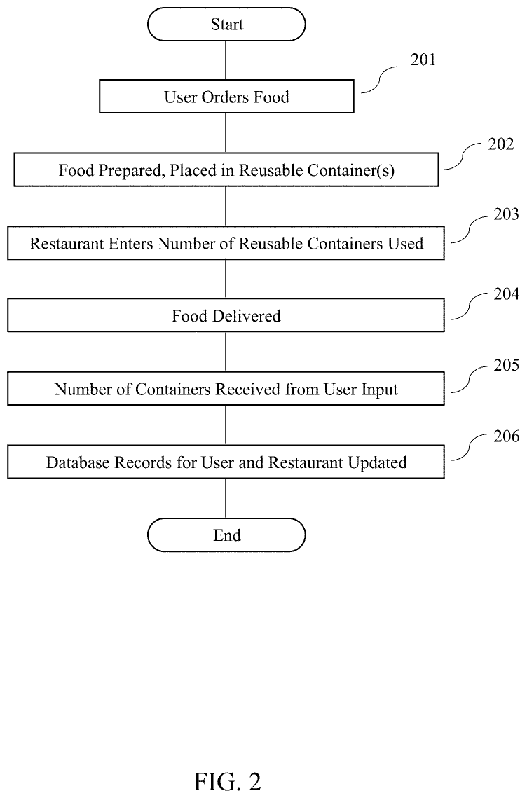

Described now is a usage scenario with reference to FIG. 2. Jane is hungry and she wants to order takeout. But she cares about the environment and she doesn't want to get her food in disposable, one-time-use packaging. So she begins her ordering by visiting a webpage, for the example entitled “DeliverZero.com,” where she knows all of the food is delivered in reusable packaging.

On DeliverZero.com, Jane finds a dozen different restaurant menus. She is in the mood for Thai food. So in step 201 she orders, through DeliverZero.com, Pad Thai and a chicken satay appetizer from a restaurant, for the example entitled “Joe's Restaurant.” DeliverZero.com collects Jane's money and transmits Jane's order to a computer at Joe's Restaurant. Because the order has come through DeliverZero.com, in step 202 Joe's Restaurant prepares and packages Jane's order in the reusable FSW units that DeliverZero has previously provided to Joe's Restaurant. (Joe's Restaurant keeps the FSW units handy, in the kitchen.) At a computer running a DeliverZero application, Joe's Restaurant confirms receipt of the order and also reports that they intend to package Jane's order using 3 DeliverZero FSW units (“3 boxes out”) in step 203. In step 204, Joe then delivers the food to Jane. Now Jane has 3 FSW units. (the restaurant's courier also returns to the restaurant and indicates in step 205 on a DeliverZero application that no FSW units were returned with Jane's order (“0 boxes in”).

If DeliverZero collected a deposit from Jane (for use of the FSW units) when she ordered on DeliverZero.com, Jane will forfeit her deposit if she does not timely return the FSW units. Alternatively, DeliverZero may simply charge Jane if she fails to return the FSW units. In any event, Jane now has DeliverZero's FSW units and if she wants to avoid further charges or avoid forfeiting her deposit, she must return the FSW units.

Here's how she does that: she orders again through DeliverZero.com. This time, she orders spaghetti and meatballs from another restaurant, for the example entitled “Sarah's Restaurant.” Again, DeliverZero.com collects Jane's money and transmits Jane's order to a computer running a DeliverZero application—this time the computer is at Sarah's Restaurant. On the application, Sarah's Restaurant confirms receipt of the order and also reports that they intend to package Jane's order using 2 pieces of DeliverZero FSW units (“2 boxes out”). Sarah's Restaurant then delivers the food to Jane, packaged in the 2 FSW units. At the same time Jane accepts the delivery, Jane also returns to Sarah 3 DeliverZero FSW units (which Jane got with her last order, from Joe's Restaurant). The courier for Sarah's Restaurant returns to the restaurant with the 3 FSW units (which are added to the Restaurant's inventory for future DeliverZero.com orders). Sarah's Restaurant makes an entry in the DeliverZero application, indicating that 3 FSW units were returned with Jane's order (“3 boxes in”).

Jane is satisfied because she ordered food in reusable FSW units—and she was able to return the FSW units to not only the restaurant she originally ordered from—Joe's Restaurant—but also Sarah's Restaurant, or indeed to any restaurant in the DeliverZero network.

Joe's Restaurant and Sarah's Restaurant are satisfied because they were able to keep track of the FSW units by simply annotating Jane's orders. (Joe's Restaurant annotated Jane's order with “3 boxes out” and “0 boxes in”; Sarah's Restaurant annotated Jane's order with “2 boxes out” and “0 boxes in”.) In the hustle and bustle of a restaurant, Joe's Restaurant and Sarah's Restaurant cannot reasonably keep track of where their FSW units were going or coming from. But by associating the comings and goings of the FSW units with a specific order—not a specific person or location—and then transmitting that information to a central database (maintained by DeliverZero), they, using DeliverZero's application, were able to effectively track the order.

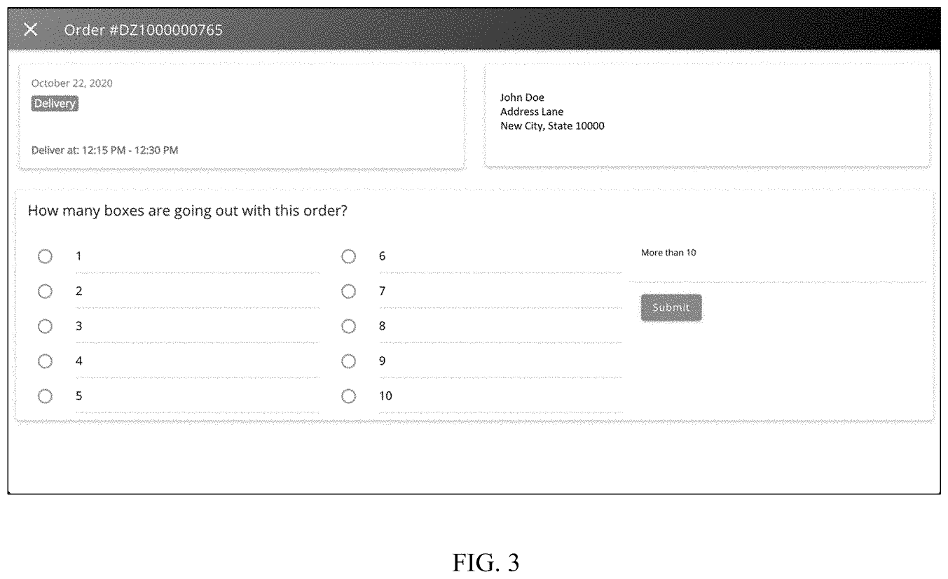

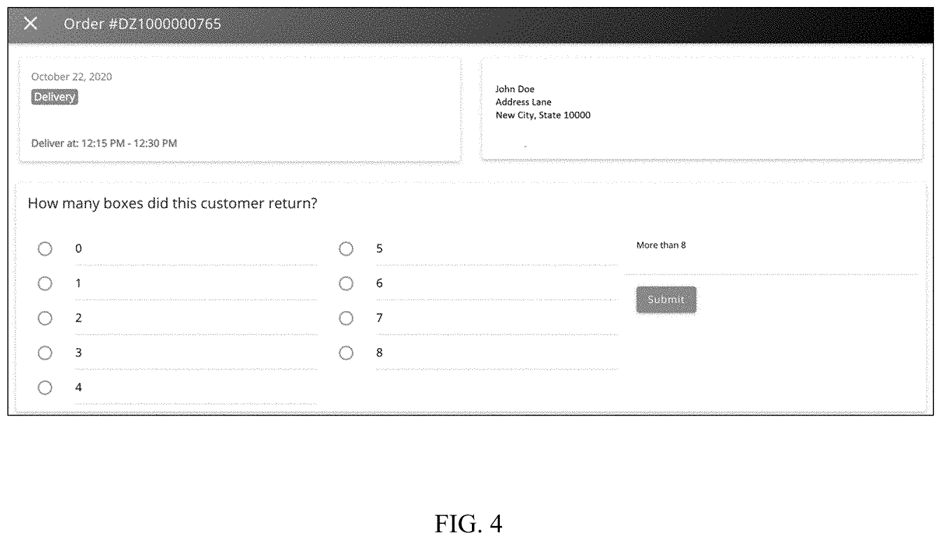

FIGS. 3-4 depict, respectively, user interfaces as presented on an electronic device wherein the restaurant can input the numbers of FSW units used to fulfill an order and how many are returned by the customer.

In certain alternate embodiments, neither the restaurant or a courier receive or track the FSW units returned by the customer. Rather, an alternative collection mechanism is employed. This may be the FSW unit provider directly collecting from the customer via drop box, post or return post or via an in-person agent. Alternatively, the FSW unit provider can employ a third-party agent to collect the FSW at a date independent of any food delivery.

FSW-Tracking Entries Made on Restaurant's Computer

The owner of the FSW units distributes the FSW units to a food seller or food sellers. The owner records the quantity and type of FSW units distributed to each food seller in a database that is linked to, and accessible by, a remote computer (such as a desktop computer, tablet or smart phone) running an application accessible by a food seller, who has an individual log-in credential.

When a food buyer purchases food from food seller, through owner's website, the order is transmitted to the food seller's remote computer. The order, as displayed on the remote computer, shows: the items that the food seller seeks to purchase; identifying information about the buyer, such as name, phone number, and address; and the quantity, or quantity and type, of FSW units that the food seller is expected to use to fill the order.

Using the remote computer, the food seller is able to adjust the order, i.e., change the price and/or items that the food buyer has purchased; and the quantity, or quantity and type, of FSW units that food seller will use (or has used) to fill the order.

Following any adjustments (or no adjustments) the food seller may then confirm the order on the remote computer. Once the order is confirmed, the remote computer transmits to owner's database the final details of the order. With respect to the FSW, the confirmation reflects that such-and-such quantity, or quantity and type, of FSW will be (or is now) distributed to (“checked out” to) the food buyer who placed the order.

After the food seller delivers the order (including the food and the FSW units) to the food buyer (either at the food seller's location; or, by courier, at the food buyer's location), the food seller may collect from food buyer any FSW units belonging to owner that is in the food buyer's possession (i.e., the food buyer may have previously ordered food through owner's website and therefore has in her possession owner's FSW units). The food seller may then record on the remote computer the quantity, or quantity and type, of FSW units collected from food buyer.

This information may be conveniently associated with food buyer's outgoing order. That is, the remote computer permits the food seller to record and associate the FSW units “checked in” to the food seller, with food buyer's outgoing order.

In this way, the completed order reflects the food items purchased; identifying information about the food buyer; the FSW units “checked in” and the FSW units “checked out”—all of which information the remote computer transmits to owner's database.

This permits owner to conveniently record the distribution of its inventory among food sellers and food buyers and owner. It also permits owner to conveniently create invoices and notices to food seller and food buyer, such as reflect the quantity, or quantity and type, of FSW “checked out”, or “checked in” to food buyer; and the amount of money owed (in the form of deposits or payments), by food buyer or food seller, for the use of the FSW units.

FSW-Tracking Entries Made on Courier's Computer

The disclosed subject matter may also be deployed in such a way that the quantity, or quantity and type, of FSW units is inputted by a delivery courier. This works as follows.

The owner of the FSW units distributes the FSW units to a food seller or food sellers. The owner records the quantity and type of FSW units distributed to each food seller in a database that is linked to, and accessible by remote computer (such as a desktop computer, tablet or smart phone) running an application, by a courier, who has an individual log-in credential.

When the food buyer purchases food from the food seller, through owner's website, the order is transmitted to the food seller. The order, as transmitted to the food seller, shows the items that the food seller seeks to purchase; and identifying information about the buyer, such as name, phone number, and address. The food is delivered from the food seller to the food buyer by courier. Using the remote computer, the courier is able to view the order, including all associated information that owner sent to the food seller (and any adjustments made by the food seller).

Using the remote computer, the courier is also able to input the quantity, or quantity and type, of FSW units that food seller has used to fill the order (“checked out” FSW units). Once input, this information is transmitted to the owner's database. After the courier delivers the order (including the food and the FSW units) to the food buyer, the courier may collect from food buyer any FSW units belonging to owner that is in food buyer's possession (i.e., the food buyer may have previously ordered food through owner's website and therefore has in her possession owner's FSW units). The courier may then record on the remote computer the quantity, or quantity and type, of FSW units collected from food buyer. This information may be conveniently associated with food buyer's outgoing order. That is, the remote computer permits the courier to record and associate the FSW units “checked in” to the courier, with food buyer's outgoing order.

In this way, the completed order reflects the food items purchased; identifying information about the food buyer; the FSW units “checked in” to the courier and the FSW units “checked out” to the food buyer—all of which information the remote computer transmits to owner's database.

This permits owner to conveniently record the distribution of its inventory among food sellers, couriers, food buyers and owner. It also permits owner to conveniently create invoices and notices to the food seller and the food buyer, such as reflect the quantity, or quantity and type, of FSW units “checked out”, or “checked in” to courier; and the amount of money owed (in the form of deposits or payments), by food buyer or food seller, for the use of the FSW units.

The disclosed subject matter may also be deployed by combining the functionalities of the food seller's and courier's remote computers (as described, respectively, in the foregoing sections), such that one or more of the functionalities described as implemented on the food seller's remote computer may be implemented on courier's remote computer, or vice versa.

What is claimed:

1. A method of managing an inventory of reusable food service ware (FSW) units, comprising the steps of:
providing to a plurality of restaurants a plurality of FSW units;
receiving to a website an order from a customer for at least one food item at one of the plurality of restaurants, whereby the order is transmitted from the website to the one of the plurality of restaurants which completes the order by placing the at least one food item in at least one of the FSW units;
receiving a first count of the number of the FSW units used to complete the order; and
updating in a database a first record associated with the customer including a second count of outstanding FSW units according to the first count.

2. The method of claim 1, further comprising the steps:
receiving a third count of the number of the FSW units received from the customer;
updating in the database the first record according to the third count; and
updating in a database a second record associated with the one of the restaurants including a fourth count of the number of possessed FSW units according to the first count and the third count.

3. The method of claim 1, further comprising the step:
updating in a database a second record associated with the one of the restaurants including a third count of the number of available FSW units according to the first count.

4. The method of claim 2 wherein the first record and the second record reflect the FSW unit sizes associated with the second count and the fourth count.

5. The method of claim 1 wherein the first record includes the date each FSW unit included in the second count was received by the customer.

6. The method of claim 5 further comprising:
generating a charge to the first record when the first record reflects that a FSW unit has not been received from the customer for a predetermined time period.

7. The method of claim 1 further comprising:
generating a charge to the first record when the second count exceeds a predetermined threshold.

8. The method of claim 2 further comprising:
generating a ticket to deliver additional FSW units when the fourth count drops below a predetermined threshold.

9. A method of managing an inventory of FSW units, comprising the steps of:
maintaining a database including a first record associated with a customer and having a first count of outstanding FSW units, and a second record associated with a restaurant and having a second count of available FSW units;
receiving a report containing a third count representing the number of the FSW units the restaurant used to fill an order from the customer and updating the second record;
receiving a report containing a fourth count representing the number of the FSW units the customer has returned and updating the first record.

10. The method of claim 9 wherein the first record and the second record reflect the FSW unit sizes associated with the third count and the fourth count.

11. The method of claim 9 wherein the first record includes the date each FSW unit included in the third count was received by the customer.

12. The method of claim 11 further comprising:
generating a charge to the first record when the first record reflects that a FSW unit has not been received from the customer for a predetermined time period.

13. The method of claim 9 further comprising:
generating a charge to the first record when the first count exceeds a predetermined threshold.

14. The method of claim 9 further comprising:
generating a ticket to deliver additional FSW units when the second count drops below a predetermined threshold.

15. A method of managing an inventory of FSW units, comprising the steps of:
maintaining a first count of the number of FSW units a user has outstanding;
receiving an order for food at a restaurant and relaying the order to the restaurant;
receiving a second count from the restaurant of the number of FSW units used to fill the order and updating the first count; and
receiving a third count of the number of FSW units returned by the user and updating the first count.

16. The method of claim 15, further comprising:
updating a fourth count of the number of FSW units the restaurant possesses according to the second count.

17. The method of claim 15, further comprising:
updating a fourth count of the number of FSW units the restaurant possesses according to the second count and the third count.

18. The method of claim 15, further comprising:
generating a reminder when the first count exceeds a predetermined threshold.

19. The method of claim 16, further comprising:
generating a ticket to deliver additional food containers to the restaurant when the fourth count reaches a predetermined threshold.
